(19) United States
(12) Patent Application Publication
(10) Pub. No.: US 2011/0210114 A1
(43) Pub. Date: Sep. 1, 2011

(54) CONVEYOR OVEN AND METHOD FOR HANDLING HEATED AIR

(75) Inventor: Jason Edward LAUER, Fort Wayne, IN (US)

(73) Assignee: MERCO/SAVORY LLC

(21) Appl. No.: 13/034,914

(22) Filed: Feb. 25, 2011

Related U.S. Application Data
(60) Provisional application No. 61/308,584, filed on Feb. 26, 2010.

(51) Int. Cl. F24C 15/32; A47J 37/04; F24F 7/007

(52) U.S. Cl. 219/388; 99/443 C; 454/49; 454/338

(57) ABSTRACT

A conveyor oven includes a housing surrounding an oven chamber having an inlet and an outlet. A conveyor belt moves food product through the oven chamber from the inlet to the outlet. A heated air handling device removes heated air from areas proximal to the inlet and the outlet.

### RELATED APPLICATION

This application claims the benefit of U.S. Provisional Application Ser. No. 61/308,584, filed Feb. 26, 2010, the entire contents of which are incorporated herein by reference.

### BACKGROUND

1. Field of the Disclosure

The present disclosure relates generally to a conveyor oven and method for handling heated air to avoid harm to a user.

2. Description of Related Art

Conveyorized ovens include a conveyor belt that moves food from a position where a user places the food on a conveyor belt through a first opening to an oven cavity where the food is cooked and out of the oven cavity through a second opening to be retrieved by the user. When a restaurant makes a decision on buying a piece of equipment, such as, a conveyorized oven, many characteristics are evaluated, for example, form size, shape, features, cost and safety. The restaurant does not want employees getting hurt on a piece of equipment. Temperature of the oven cavity of the conveyorized oven is undesirably restricted so that the heat in the oven cavity does not heat parts of the oven that can easily be touched by employees by accident or on purpose. The restricted or lower temperatures result in an oven that requires undesirably long heating times.

Accordingly, there is a need for an improved conveyor oven and method for handling heated air

### SUMMARY OF THE DISCLOSURE

In one embodiment of the conveyor oven for cooking food products of the present disclosure, the conveyor oven comprises a housing defining an oven chamber having an inlet and an outlet. A conveyor that extends through said inlet into said oven chamber and comprises a conveyor belt driven to transport food product into said oven chamber. A heating element is disposed in proximity to said conveyor to provide heat to cook said food product in said oven chamber. A heated air handling device draws heated air that exits said oven chamber via said inlet or said outlet through a ductwork and expels the heated air from said ductwork to ambient in a direction away from said inlet and outlet to avoid harm to a user of the conveyor oven.

In another embodiment of the conveyor oven of the present disclosure, said heated air handling device comprises either a first fan to draw said heated air or said first fan and a second fan to draw said heated air from said inlet and said outlet, respectively.

In another embodiment of the conveyor oven of the present disclosure, the heated air handling device further comprises first and second vents aligned with said first and second fans, respectively, through which said heated air is expelled.

In another embodiment of the conveyor oven of the present disclosure, said ductwork is positioned at least in part above said conveyor belt.

In another embodiment of the conveyor oven of the present disclosure, said ductwork comprises a portion of a top of said housing.

In another embodiment of the conveyor oven of the present disclosure, said heated air is expelled from at least one vent located in said portion.

In another embodiment of the conveyor oven of the present disclosure, said ductwork further comprises a front wall and or a rear wall of said housing connected to said portion.

In one embodiment of the method for removing heated air of a conveyor oven of the present disclosure, there is provided a housing that defines an oven chamber having an inlet and an outlet. There is further provided a conveyor that extends through said inlet into said oven chamber and that comprises a conveyor belt driven to transport food product into said oven chamber. Heat is provided to cook said food product in said oven chamber. Heated air that exits said oven chamber via said inlet or said outlet is drawn through a ductwork and expelled from said ductwork to ambient in a direction away from said inlet and outlet to avoid harm to a user of the conveyor oven.

In another embodiment of the method of the present disclosure, said drawing step uses either a first fan to draw said heated air or said first fan and a second fan to draw said heated air from said inlet and said outlet, respectively.

In another embodiment of the method of the present disclosure, a further step aligns first and second vents with said first and second fans, respectively, through which said heated air is expelled.

In another embodiment of the method of the present disclosure, said ductwork is positioned at least in part above said conveyor belt.

In another embodiment of the method of the present disclosure, said ductwork comprises a portion of a top of said housing.

In another embodiment of the method of the present disclosure, said heated air is expelled from at least one vent located in said portion.

In another embodiment of the method of the present disclosure, said ductwork further comprises a front wall and or a rear wall of said housing connected to said portion.

The above-described and other advantages and features of the present disclosure will be appreciated and understood by those skilled in the art from the following detailed description and drawings.

### BRIEF DESCRIPTION OF THE DRAWINGS

FIG. 1 is a top side perspective view of a conveyor oven having a heated air handling device according to the present disclosure.

FIG. 2 is a schematic top view of the conveyor oven of FIG. 1.

FIG. 3 is a schematic side view of the conveyor oven of FIG. 1.

FIG. 4 is a schematic front view of the conveyor oven of FIG. 1.

FIG. 5 is a bottom side perspective view of the conveyor oven of FIG. 1 with a bottom compartment removed therefrom.

FIG. 6 is a bottom front perspective view of the conveyor oven of FIG. 1 with the bottom compartment removed therefrom.

FIG. 7 is a schematic top side perspective view of the conveyor oven of FIG. 1 having a first side wall removed.

FIG. 8 is a schematic top side perspective view of the conveyor oven of FIG. 1 having a second side wall removed.

FIG. 9 is a schematic exploded view of the conveyor oven of FIG. 1.

FIG. 10 is a schematic exploded view of the heated air handling device of the conveyor oven of FIG. 1.

### DETAILED DESCRIPTION OF THE PREFERRED EMBODIMENT

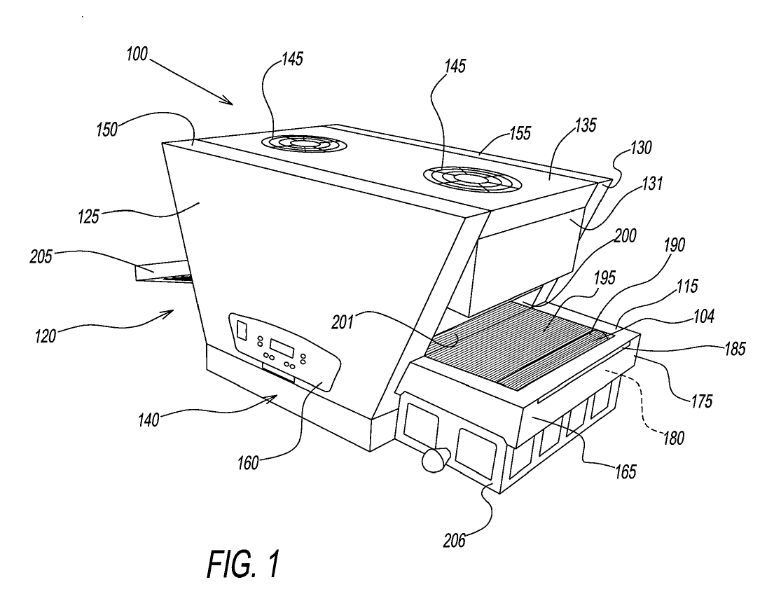

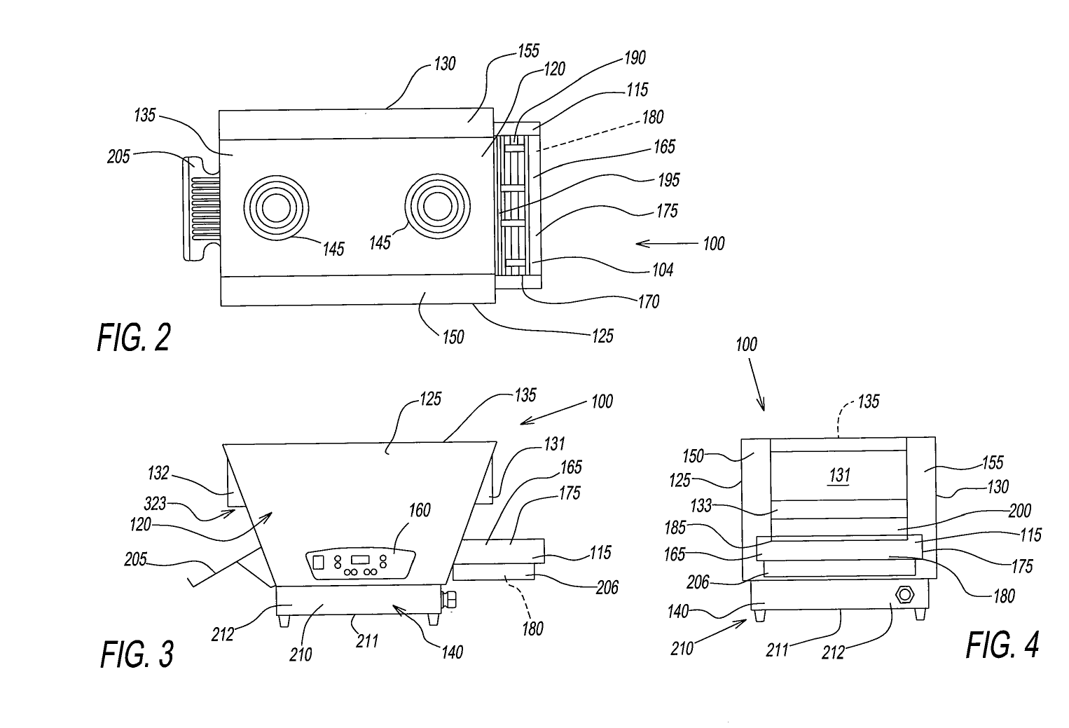

Referring to the drawings and in particular to FIGS. 1-4, an exemplary embodiment of a conveyor oven according to the present disclosure is generally referred to by reference numeral 100. Conveyor oven 100 comprises a conveyor 104, a housing 120 and a conveyor frame 115. Housing 120 has a first side wall 125, a second side wall 130, a first front wall 131, a rear wall 132, a second front wall 133, a bottom wall 225 and a top wall 135 that define an oven cavity or oven chamber 200 having an inlet 201 and an outlet 323. Housing 120 is connected to a bottom compartment 140. Top wall 135 has apertures 145. First side wall 125 covers a first compartment or side wall passage 150. Second side wall 130 covers a second compartment or side wall passage 155. A user interface 160 is disposed on first side wall 125. A user can use user interface 160 to enter data for cooking instructions or other data for conveyor oven 100. Conveyor 104 comprises a conveyor belt 195 that extends through inlet 201 into oven chamber 200 and is supported by housing 120. Conveyor frame 115 surrounds at least a portion of conveyor belt 195 that is outside inlet 201.

Conveyor frame 115 is hollow as defined by an outer wall assembly 165 and an inner wall assembly 170 that form a frame compartment or passage 175 having an interior volume 180 therebetween. Outer wall assembly 165 has apertures 185 therethrough allowing fluid communication between interior volume 180 and an ambient environment surrounding conveyor frame 115. Inner wall assembly 170 is connected to a drive shaft assembly 190, which moves conveyor belt 195. Food is placed on conveyor belt 195 by a user so that conveyor belt 195 moves the food from a position within conveyor frame 115 through oven chamber 200 to a rear tray 205. Conveyor frame 115 may be connected above an external crumb tray 206 that collects any loose debris or particles from conveyor belt 195 due to the user placing food product on conveyor belt 195.

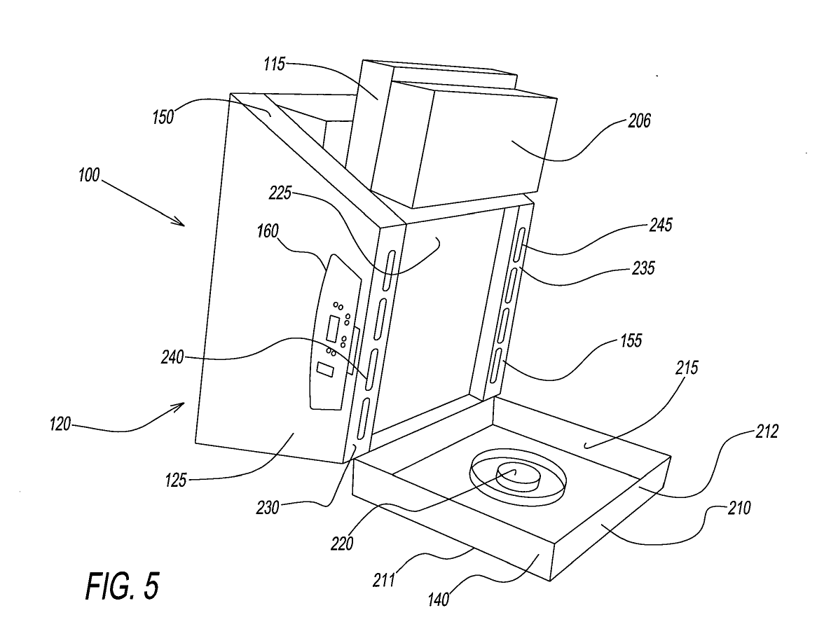

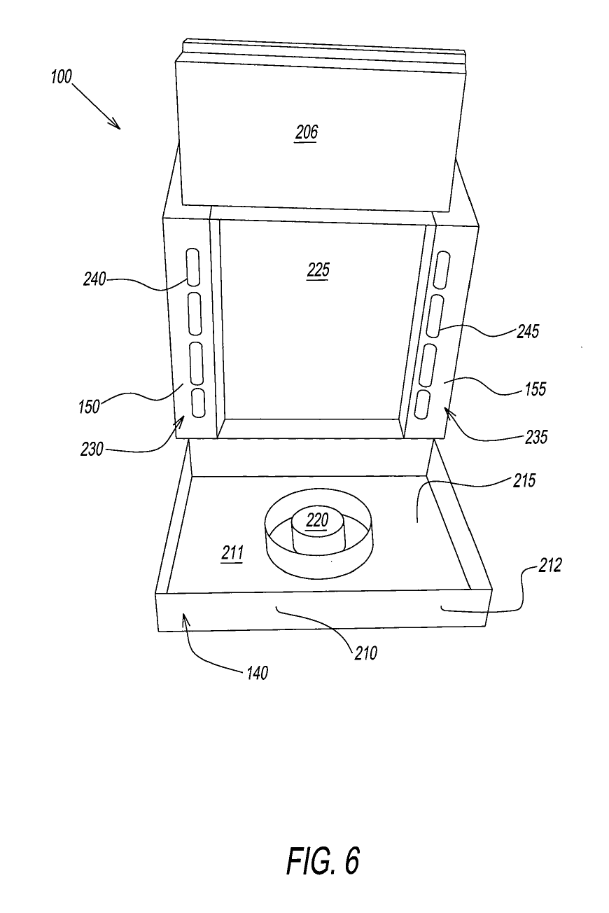

Referring now to FIGS. 3-6, bottom compartment 140 comprises a bottom housing 210 with a base wall 211 and a base side wall 212 forming a bottom interior volume 215 that houses a fan 220. When bottom compartment 140 is connected to housing 120, interior volume 215 is covered by a bottom wall 225 of housing 120 and a first bottom side wall 230 of first compartment 150 and a second bottom side wall 235 of second compartment 155. First bottom side wall 230 has apertures 240 therethrough and second bottom side wall 235 has apertures 245 therethrough to provide fluid communication between interior volume 215 and side wall compartments 150 and 155.

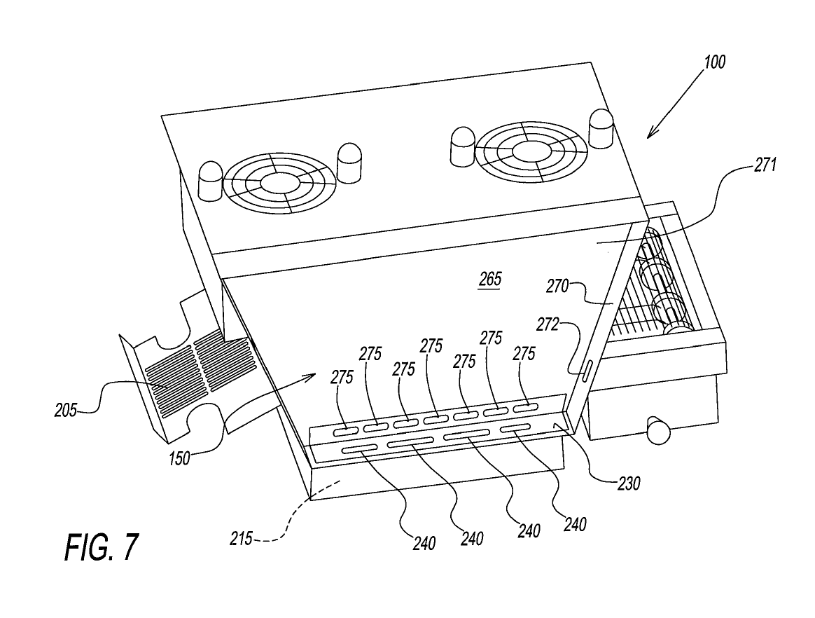

Referring now to FIG. 7, first compartment 150 has a first back panel 265 surrounded by a first compartment side wall 270 forming a first compartment interior 271. First back panel 265 has apertures 275 therethrough adjacent an edge that connects to first bottom side wall 230. First compartment side wall 270 has an aperture 272 therethrough from first compartment interior 271 to interior volume 180 in conveyor frame 115.

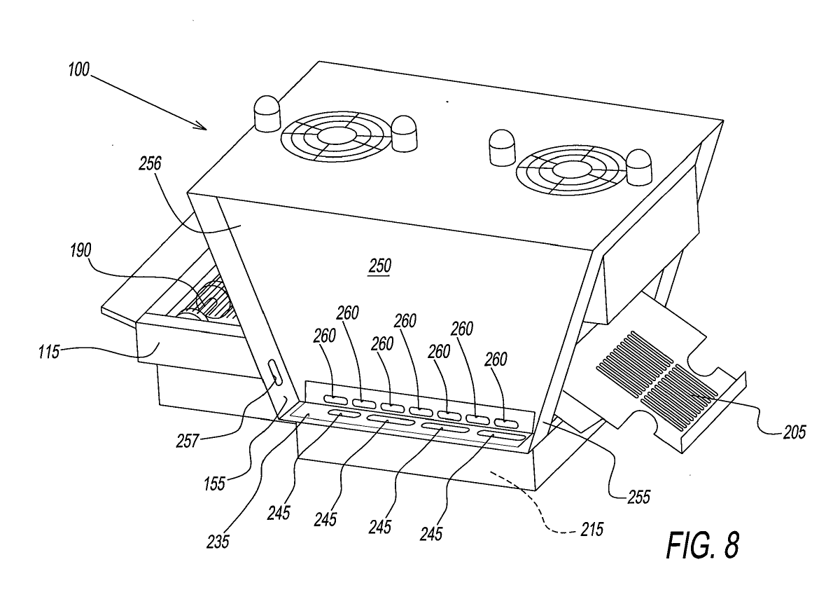

Referring now to FIG. 8, second compartment 155 has a second back panel 250 surrounded by a second compartment side wall 255 forming a second compartment interior 256. Second back panel 250 has apertures 260 therethrough adjacent an edge that connects to second bottom side wall 235. Second compartment side wall 255 has an aperture 257 therethrough from second compartment interior 256 to interior volume 180 in conveyor frame 115.

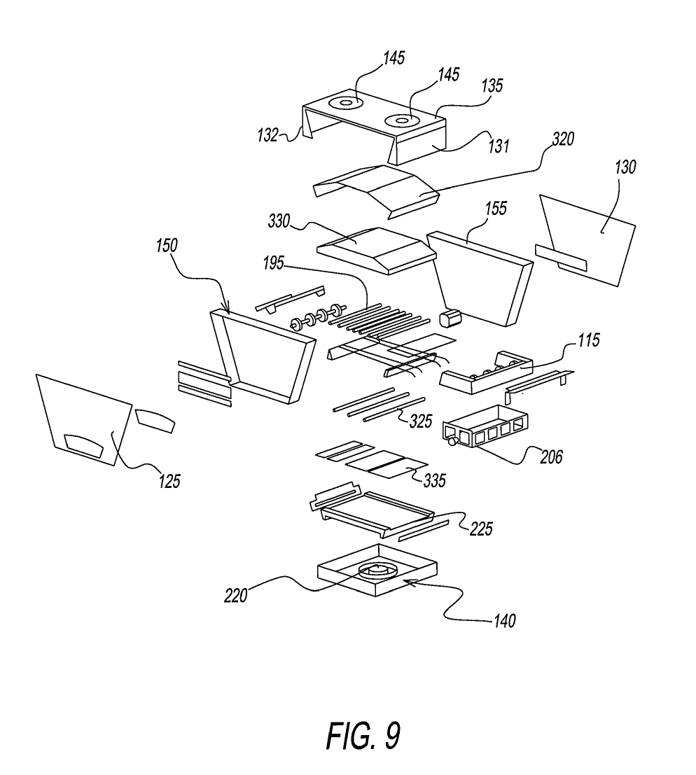

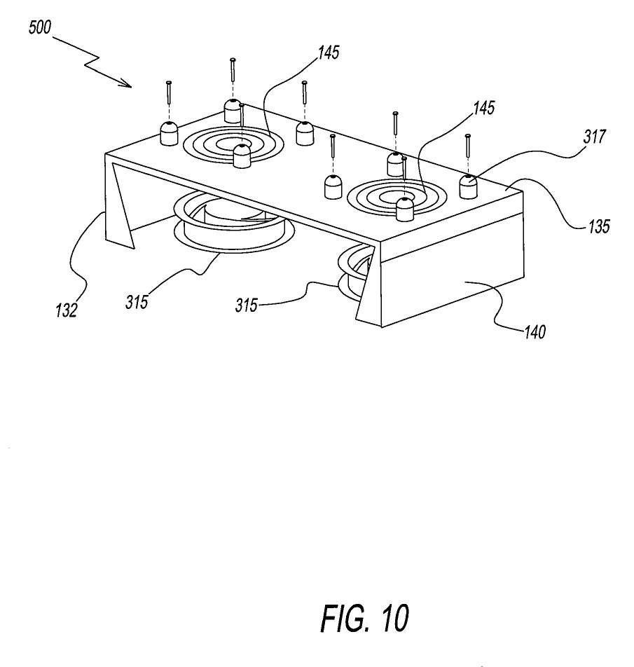

Referring now to FIGS. 9 and 10, conveyor oven 100 further comprises a heated air handling device 500 having a pair of fans 315. Fans 315 are connected to top wall 135. Each of fans 315 is connected in alignment to adjacent apertures 145 on top wall 135. Alternatively, a single fan may be used. Bumpers 317, for example, rubber bumpers, are connected to top wall 135. Bumpers 317 may be connected to screws that connect each of fans 315 to top wall 135. Fans 315 each have a motor (not shown) to rotate each of fans 315. The motors may be connected to a power source of conveyor oven 100 so that there is no need for extra plugs or drop cords, fans 315 are powered by a power source (not shown) of conveyor oven 100 itself. Fans 315 may each be activated and deactivated when conveyor oven 100 is activated and deactivated.

A top panel 320 is connected between first compartment 150 and second compartment 155 to form a space between top panel 320 and each of top wall 135, front wall 131 and rear wall 132. Front wall 131 forms a first duct with top panel 320 and rear wall 132 forms a second duct with top panel 320 in the space. Referring also to FIG. 3, the first duct has a first duct inlet 324. The second duct has a second duct inlet 326. A volume is formed between top wall 135 and top panel 320 that is connected to and in fluid communication with the first duct and the second duct. Fans 315 draw air from just above conveyor belt 195 through first duct inlet 324 through the first duct to the volume between top wall 135 and top panel 320. Fans 315 draw air from just above conveyor belt 195 through the second duct inlet 326 through the second duct to the volume between top wall 135 and top panel 320. The air flows from the volume between top wall 135 and top panel 320 through fans 315 and through apertures 145 in top wall 135 to the ambient environment surrounding conveyor oven 100.

In the world of everything has to be faster, lines at restaurants are quickly becoming more flow oriented. When a restaurant makes a decision on buying a piece of equipment many characteristics are evaluated from size, shape, features, cost and safety. The restaurant does not want employees getting hurt on a piece of equipment. Since being fast is so important the demands of time cause temperature of an oven cavity to keep getting hotter and hotter until the heat in the oven cavity starts to heat up parts of the oven that can easily be touched by employees by accident or on purpose. This is where the integrated heated air handling device 500 is advantageous, because fans 320 are built into conveyor oven 100 there is no a need for extra plugs or drop cords, fans 320 are powered by conveyor oven 100 itself. This design allows for the removal or diversion of hot air from an area X, as shown in FIG. 1, where the food is loaded and an area Y, as shown in FIG. 3, where the food is unloaded from conveyor oven 100 by pulling hot air from inlet 206 and outlet 323 to oven chamber 200, as shown in FIGS. 3 and 4, by way the first duct and the second duct on the front and rear of conveyor oven 100 just above rear tray 205 and conveyor belt 195. Once the air passes through the first duct and the second duct, the air gathers in the volume between top panel 320 and top wall 135 that is an upper holding area before the air is expelled out into the ambient environment surrounding conveyor oven 100 by fans 315.

Advantageously, heated air handling device 500 greatly reduces a possibility of injury by placing food on or taking food off conveyor belt 195. When conveyor oven 100 is safe then the employees only have to worry about food and not getting injured.

Conveyor oven 100 may be capable of a wide variety of end of the line finishing applications of food. Conveyor oven 100 may be a toaster that includes cooling device 500 on a top, which facilitates removal of air from areas around openings to oven chamber 200. Integrating fans 315 into a design of conveyor oven 100 allows for ease of powering, and will allow users of conveyor oven 100 a safer condition to work in when around conveyor oven 100.

Heating elements 325 are connected between first compartment 150 and second compartment 155. A reflecting assembly 330 may be positioned between top panel 320 and heating elements 325. An interior crumb tray 335 may be placed between bottom wall 225 and conveyor belt 195.

It should also be noted that the terms “first”, “second”, “third”, “upper”, “lower”, “above”, “below”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A conveyor oven for cooking food products comprising:
a housing defining an oven chamber having an inlet and an outlet;
a conveyor that extends through said inlet into said oven chamber and that comprises a conveyor belt driven to transport food product into said oven chamber;
a heating element disposed in proximity to said conveyor to provide heat to cook said food product in said oven chamber;
a heated air handling device that draws heated air that exits said oven chamber via said inlet or said outlet through a ductwork and expels the heated air from said ductwork to ambient in a direction away from said inlet and outlet to avoid harm to a user of the conveyor oven.

2. The conveyor oven of claim 1, wherein said heated air handling device comprises either a first fan to draw said heated air or said first fan and a second fan to draw said heated air from said inlet and said outlet, respectively.

3. The conveyor oven of claim 2, wherein said heated air handling device further comprises first and second vents aligned with said first and second fans, respectively, through which said heated air is expelled.

4. The conveyor oven of claim 1, wherein said ductwork is positioned at least in part above said conveyor belt.

5. The conveyor oven of claim 4, wherein said ductwork comprises a portion of a top of said housing.

6. The conveyor oven of claim 5, wherein said heated air is expelled from at least one vent located in said portion.

7. The conveyor oven of claim 6, wherein said ductwork further comprises a front wall and or a rear wall of said housing connected to said portion.

8. A method of removing heated air of a conveyor oven comprising:
providing a housing defining an oven chamber having an inlet and an outlet,
providing a conveyor that extends through said inlet into said oven chamber and that comprises a conveyor belt driven to transport food product into said oven chamber;
providing heat to cook said food product in said oven chamber;
drawing heated air that exits said oven chamber via said inlet or said outlet through a ductwork;
expelling the heated air from said ductwork to ambient in a direction away from said inlet and outlet to avoid harm to a user of the conveyor oven.

9. The method of claim 8, wherein said drawing step uses either a first fan to draw said heated air or said first fan and a second fan to draw said heated air from said inlet and said outlet, respectively.

10. The method of claim 9, further comprising aligning first and second vents with said first and second fans, respectively, through which said heated air is expelled.

11. The method of claim 8, wherein said ductwork is positioned at least in part above said conveyor belt.

12. The method of claim 11, wherein said ductwork comprises a portion of a top of said housing.

13. The method of claim 12, wherein said heated air is expelled from at least one vent located in said portion.

14. The method of claim 13, wherein said ductwork further comprises a front wall and or a rear wall of said housing connected to said portion.
